(19) United States
(12) Patent Application Publication
(10) Pub. No.: US 2018/0143347 A1
(43) Pub. Date: May 24, 2018

(54) Automated Tropical Cyclone Genesis Definition and Tracking

(71) Applicant: The Government of the United States of America, as represented by the Secretary of the Navy, Arlington, VA (US)

(72) Inventors: Charles R. Sampson, Aptos, CA (US); Ann Schrader, Pacific Grove, CA (US); Michael D. Frost, Monterey, CA (US)

(73) Assignee: The Government of the United States of America, as represented by the Secretary of the Navy, Arlington, VA (US)

(21) Appl. No.: 15/816,069

(22) Filed: Nov. 17, 2017

Related U.S. Application Data
(60) Provisional application No. 62/423,789, filed on Nov. 18, 2016.

(51) Int. Cl. G01W 1/10; G06F 17/50; G06N 7/00

(52) U.S. Cl. CPC G01W 1/10; G06F 3/04847; G06N 7/005; G06F 17/5009

(57) ABSTRACT

A computer-implemented system and method for defining, tracking, and analyzing tropical cyclone genesis areas as part of an integrated computer-implemented tropical cyclone forecasting and analysis system.

### CROSS-REFERENCE

This Application is a Nonprovisional of, and claims the benefit of priority under 35 U.S.C. § 119 based on, U.S. Provisional Patent Application No. 62/423,789 filed on Nov. 18, 2016. The Provisional Application and all references cited herein are hereby incorporated by reference into the present disclosure in their entirety.

### TECHNICAL FIELD

The present disclosure relates to the tracking and forecasting of tropical cyclones, particularly to the tracking and analysis of weather phenomena and associated geographic areas in which a tropical cyclone may develop.

### BACKGROUND

The National Hurricane Center (NHC) uses the term “tropical cyclone” or “TC” as a generic term for a non-frontal synoptic-scale (i.e., on the order of 1000 km) low-pressure system over tropical or sub-tropical waters, where the system exhibits organized convection (i.e. thunderstorm activity) and definite cyclonic surface wind circulation.

Intense tropical cyclones can wreak havoc on coastal areas, destroying property and threatening life. Even if such storms do not make landfall, tropical cyclones create significant problems for both military and commercial maritime activities, often requiring these activities to make expensive and time-consuming changes to their operations.

Accurate forecasts of the track, intensity and size of tropical cyclones is thus critical for operations planning and for avoiding damages and loss of life.

NHC, along with the Joint Typhoon Warning Center (JTWC) and the Central Pacific Hurricane Center (CPHC), create tropical cyclone forecasts for the entire globe. Previously there were no automated methods to define, track, assign probabilities to, or delete genesis areas, i.e., geographic areas where environmental and/or climatological conditions are such that one or more tropical cyclones may develop. As skill in genesis forecasting (i.e., forecasting when and where tropical cyclone development will occur) improves and public demand for products addressing genesis increases, there is a need for a system that can be integrated into a tropical cyclone tracking and forecasting system so that such storms can be rapidly and accurately identified and tracked.

The Automated Tropical Cyclone Forecasting System (ATCF) has been developed at the U.S. Naval Research Laboratory to provide optimized tropical cyclone tracking and forecasting through the use of current and past cyclone data, numerical weather prediction (NWP) model fields, objective forecast guidance, and objective observations. See Charles R. Sampson and Ann J. Schrader, “The Automated Tropical Cyclone Forecasting System (Version 3.2),” Bulletin of the American Meteorological Society, pp. 1231-1240 (1999), the entirety of which is hereby incorporated by reference into the present disclosure.

### SUMMARY

This summary is intended to introduce, in simplified form, a selection of concepts that are further described in the Detailed Description. This summary is not intended to identify key or essential features of the claimed subject matter, nor is it intended to be used as an aid in determining the scope of the claimed subject matter. Instead, it is merely presented as a brief overview of the subject matter described and claimed herein.

The present invention provides a computer-implemented system and method for defining, tracking, and analyzing tropical cyclone genesis areas as part of an integrated computer-implemented tropical cyclone forecasting and analysis system, with the steps described herein being implemented by one or more processors programmed with appropriate software to enable them to work with such a system.

### BRIEF DESCRIPTION OF THE DRAWINGS

FIG. 1 is a screen shot of an exemplary graphical user interface that can be used to implement one or more aspects of an automated system and method for identifying and tracking tropical cyclone genesis areas in accordance with one or more aspects of the present invention.

FIG. 2 is a screen shot of an additional aspect of an exemplary graphical user interface that can be used to implement one or more aspects of an automated system and method for identifying and tracking tropical cyclone genesis areas in accordance with one or more aspects of the present invention.

FIG. 3 is a screen shot of an additional aspect of an exemplary graphical user interface that can be used to implement one or more aspects of an automated system and method for identifying and tracking tropical cyclone genesis areas in accordance with one or more aspects of the present invention.

FIG. 4 is a screen shot of an additional aspect of an exemplary graphical user interface that can be used to implement one or more aspects of an automated system and method for identifying and tracking tropical cyclone genesis areas in accordance with one or more aspects of the present invention.

FIGS. 5A and 5B are screen shots of additional aspects of an exemplary graphical user interface that can be used to implement one or more aspects of an automated system and method for identifying and tracking tropical cyclone genesis areas in accordance with one or more aspects of the present invention.

FIG. 6 is a screen shot of an additional aspect of an exemplary graphical user interface that can be used to implement one or more aspects of an automated system and method for identifying and tracking tropical cyclone genesis areas in accordance with one or more aspects of the present invention.

FIGS. 7A and 7B are screen shots of additional aspects of an exemplary graphical user interface that can be used to implement one or more aspects of an automated system and method for identifying and tracking tropical cyclone genesis areas in accordance with one or more aspects of the present invention.

FIG. 8 is a screen shot of an additional aspect of an exemplary graphical user interface that can be used to implement one or more aspects of an automated system and method for identifying and tracking tropical cyclone genesis areas in accordance with one or more aspects of the present invention.

FIGS. 9A and 9B are screen shots of additional aspects of an exemplary graphical user interface that can be used to implement one or more aspects of an automated system and method for identifying and tracking tropical cyclone genesis areas in accordance with one or more aspects of the present invention.

FIG. 10 is a screen shot of an additional aspect of an exemplary graphical user interface that can be used to implement one or more aspects of an automated system and method for identifying and tracking tropical cyclone genesis areas in accordance with one or more aspects of the present invention.

FIGS. 11A and 11B are screen shots of additional aspects of an exemplary graphical user interface that can be used to implement one or more aspects of an automated system and method for identifying and tracking tropical cyclone genesis areas in accordance with one or more aspects of the present invention.

FIG. 12 is a screen shot of an additional aspect of an exemplary graphical user interface that can be used to implement one or more aspects of an automated system and method for identifying and tracking tropical cyclone genesis areas in accordance with one or more aspects of the present invention.

FIG. 13 is a screen shot of an additional aspect of an exemplary graphical user interface that can be used to implement one or more aspects of an automated system and method for identifying and tracking tropical cyclone genesis areas in accordance with one or more aspects of the present invention.

FIG. 14 is a screen shot of an additional aspect of an exemplary graphical user interface that can be used to implement one or more aspects of an automated system and method for identifying and tracking tropical cyclone genesis areas in accordance with one or more aspects of the present invention.

FIGS. 15A and 15B are screen shots of additional aspects of an exemplary graphical user interface that can be used to implement one or more aspects of an automated system and method for identifying and tracking tropical cyclone genesis areas in accordance with one or more aspects of the present invention.

### DETAILED DESCRIPTION

The aspects and features of the present invention summarized above can be embodied in various forms. The following description shows, by way of illustration, combinations and configurations in which the aspects and features can be put into practice. It is understood that the described aspects, features, and/or embodiments are merely examples, and that one skilled in the art may utilize other aspects, features, and/or embodiments or make structural and functional modifications without departing from the scope of the present disclosure.

The present invention provides a computer-implemented system and method for use in defining, tracking, and analyzing tropical cyclone genesis areas as part of an integrated computer-implemented tropical cyclone forecasting and analysis system, with the steps described herein being implemented by one or more processors programmed with appropriate software to enable them to work with such a system. In their current implementation, the computer-implemented tropical cyclone genesis system and method in accordance with the present disclosure form part of the ATCF and are described herein in the context of the ATCF. However, one skilled in the art will recognize that method steps and other system aspects described herein are not limited to use within the ATCF and may be used with other systems, and such other implementations and embodiments should be deemed to be within the scope and spirit of the present disclosure.

The screen shots in the FIGURES which are filed herewith and form a part of the present disclosure illustrate a typical use of the new dialogs within the present invention to identify, track, and analyze tropical cyclone genesis areas. It will be appreciated by those skilled in the art that the screen shots depicted in the FIGURES illustrate an exemplary embodiment only, and that other configurations and embodiments may also be employed to implement the method steps and other aspects described herein.

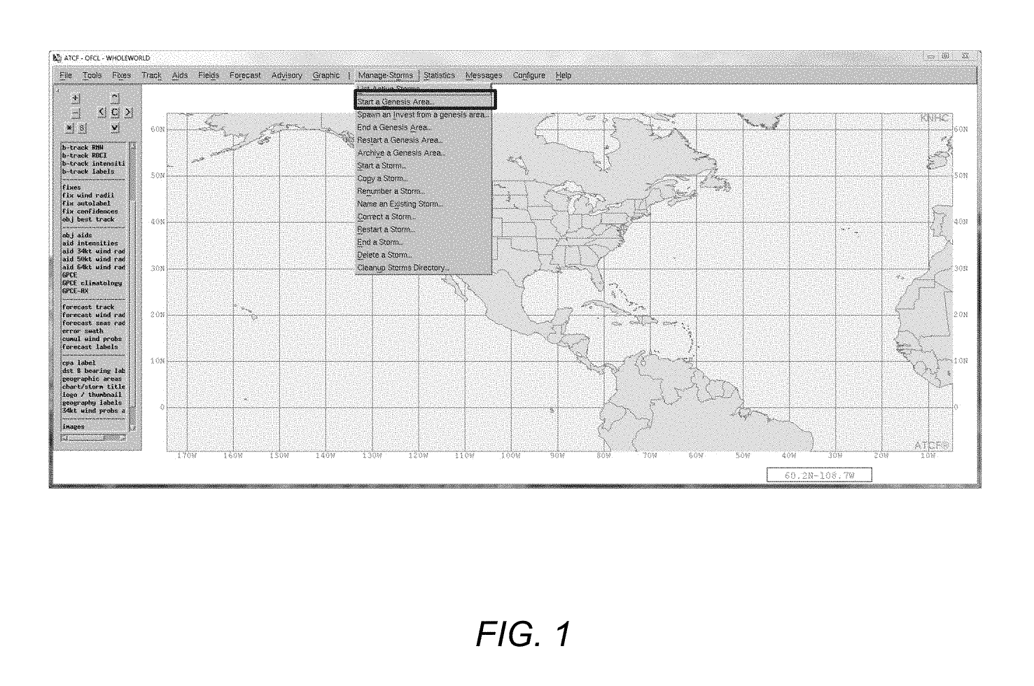

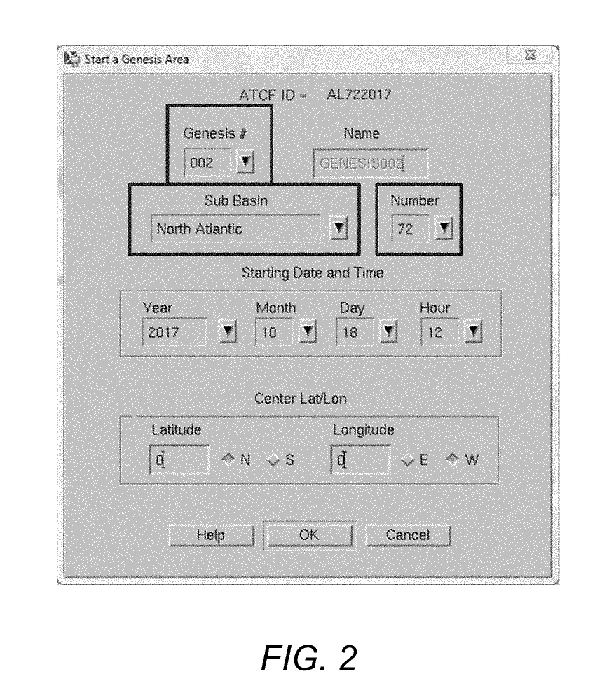

In a first step of a method for assigning, tracking, and analyzing a tropical cyclone genesis area in accordance with the present invention, a forecaster starts a genesis area in the ATCF based on an analysis of a geographical area, e.g., the Atlantic Ocean off the coast of Florida, and a determination by the forecaster that the climatological and environmental conditions in that geographical area are suitable for the potential development of a tropical cyclone. Thus, as illustrated in FIG. 1, the forecaster can start a genesis area by selecting “Manage-Storms” then “Start a Genesis Area” in the graphical user interface. As shown in FIG. 2, the “Start a Genesis Area” dialog allows the user to enter the genesis area number and genesis area's sub-basin, storm number, starting date and time, and the initial latitude/longitude (“lat/lon”) of the genesis area. The lat/lon's can be rough estimates and can be modified later based on subsequent tracking information.

A key innovation of the automated tropical cyclone genesis area definition and tracking system in accordance with the present invention is the use of the following numbering scheme described below that was developed by the U.S. Navy as part of the ATCF. This numbering scheme assigns a specific two-digit number to a genesis area depending on its status, where the numbering scheme permits a forecaster to easily identify, track, analyze, and manage tropical cyclone genesis areas within the tropical cyclone forecasting system.

Thus, as described in more detail below, the genesis area can be assigned one or more of the following tracking numbers depending on its status:
1-49: Fully-formed tropical cyclones that develop from a genesis area;
50-69: [Reserved];
70-79: Genesis Areas identified by the forecaster;
80-89: “Practice” Genesis Areas and/or tropical storms; and
90-99: INVESTS spawned from the genesis area as identified by the forecaster.

The numbers from 1-49 are part of the conventional tropical storm numbering scheme and have historically been used by forecasters such as those at the National Hurricane Center and the Joint Typhoon Warning Center to identify specific tropical storms that develop from a genesis area.

The numbers from 50 to 99 are part of the ATCF and, as described in more detail below, are used in the system and method of the present invention as follows:

The numbers 50-69 are reserved for internal use at the forecast centers.

The numbers 70-79 are assigned to specific genesis areas in a manner described in more detail below.

The numbers 80-89 are used to identify modeled, or “practice” genesis areas and/or storms that can be used by forecasters or others in exercises such as the “Hurrex” exercises used by the U.S. Navy to test and prepare for possible emergency conditions; such “practice” storms can also be used by forecasters to test software or other forecasting models or operations.

The numbers 90-99 are assigned to investigative areas that are referred to as “INVESTS” that may spawn from a particular genesis area, i.e., specific sub-areas within a genesis area that is being monitored for potential tropical cyclone development, e.g., because the climatological conditions within that specific sub-area are particularly suitable for the development of a tropical storm.

Thus, when a genesis area, i.e., a geographic area having climatological conditions that may be suitable for the development of a tropical storm, is identified, the genesis area number is automatically assigned a three-digit number and given a name “GENESISXXX”, “GENESIS002” as shown in FIG. 2 so that the genesis area can be tracked by any of the forecasting agencies.

In addition, in accordance with the present invention, the genesis area is also assigned an ATCF tracking number from 70 to 79 (often referred to as a “70's number”) so that it can be tracked and analyzed by the automated genesis area tracking and analysis system within the ATCF. For example, as illustrated in FIG. 2, the genesis area “GENESIS002” is also given the ATCF tracking number 72, so that the complete identifier of the storm in the ATCF genesis definition and tracking system of the present invention is given by “<ATCF tracking number><year><basin><genesis_number>, e.g., “72 2017 North Atlantic GENESIS002”.

Once the user clicks “OK” on the “Start a Genesis Area” dialog a file is created to store the TC genesis information. In the current implementation, the file is given a filename in the format “$ATCFSTRMS/b<basin><stonn number><year>.dat, e.g. “$ATCFSTRMS/bal722017.dat”, for genesis area number 72 in the Atlantic basin in the year 2017, though other filename formats may be used in other implementations. In addition, a record of this genesis area is added into the “$ATCFSTRMS/storms.txt” file, which contains a record for each active storm.

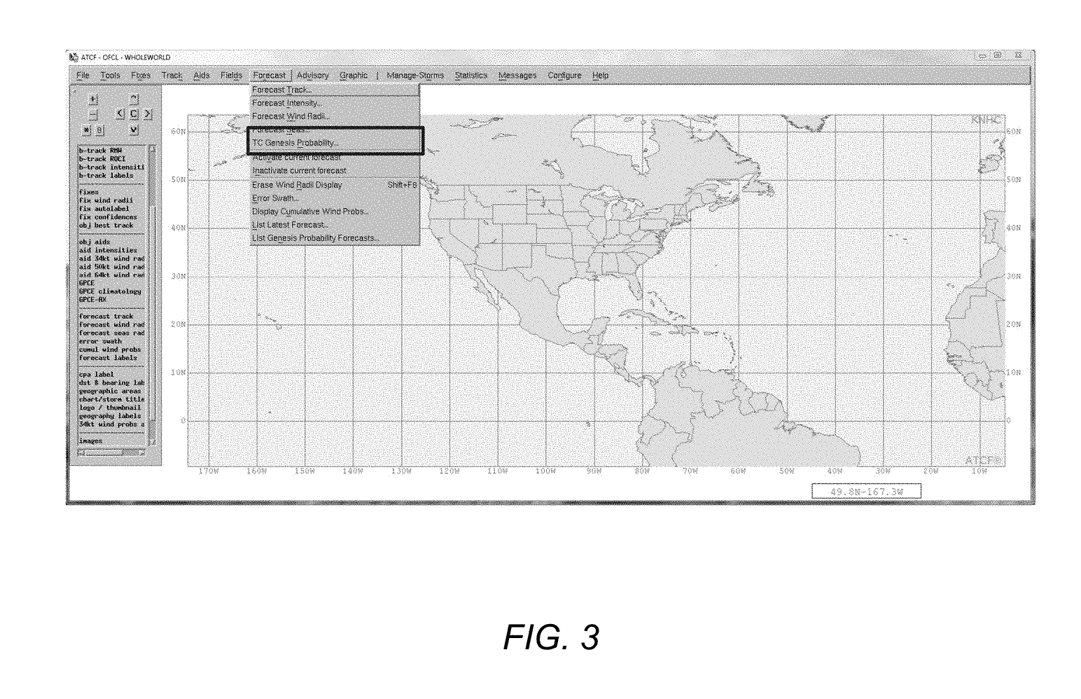

Once the genesis area has been defined and assigned a specific number between 70 and 79, the forecaster can assign a genesis probability, i.e., a probability that one or more tropical cyclones will develop out of the genesis area. The probability assignment is made by the forecaster based on his or her knowledge and skills relating to tropical cyclone genesis, and this probability assignment is then made. As illustrated in FIG. 3, the forecaster can select an option to assign a “TC Genesis Probability” from the drop-down “Forecast” menu.

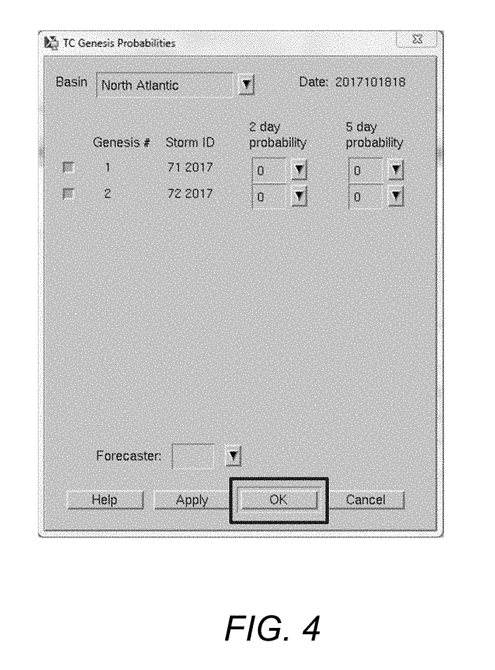

Selection of the “TC Genesis Probability” option then allows the forecaster to select from among basins having current active genesis areas, e.g., “North Atlantic,” “East Pacific,” or “Central Pacific,” as shown in FIG. 4. Once a TC genesis area is selected, as further illustrated in FIG. 4, the user can select “Forecast TC Genesis Probability” to assign a probability that a TC will develop in the genesis area.

The selection of TC Genesis Probability” from the “Forecast” menu opens a dialog box such as that shown in FIG. 4, in which the forecaster can enter probabilities that one or more of those genesis areas will develop into a tropical storm based on the current environmental conditions for that genesis area and the forecaster's knowledge. As currently implemented, such probabilities can be made for both a 2 day and a 5 day period in the future. Such probabilities can be assigned for each active genesis area in the selected basin. Once “OK” is clicked, the TC genesis probability data will be saved to a file in the ATCF. In an exemplary implementation, this file can be given a filename in the format “$ATCFSTRMS/e<basin><storm number><year>.dat, e.g. “$ATCFSTRMS/eal71.2015.dat”, for genesis area number 71 in the Atlantic basin in the year 2015, though other filename formats or file saving formats may be used in other implementations as appropriate. In addition, this information will also be saved to the file “$ATCFMESSAGES/<basin>.genprob,” e.g. as “al.genprob” for a genesis area probability in the Atlantic basin.

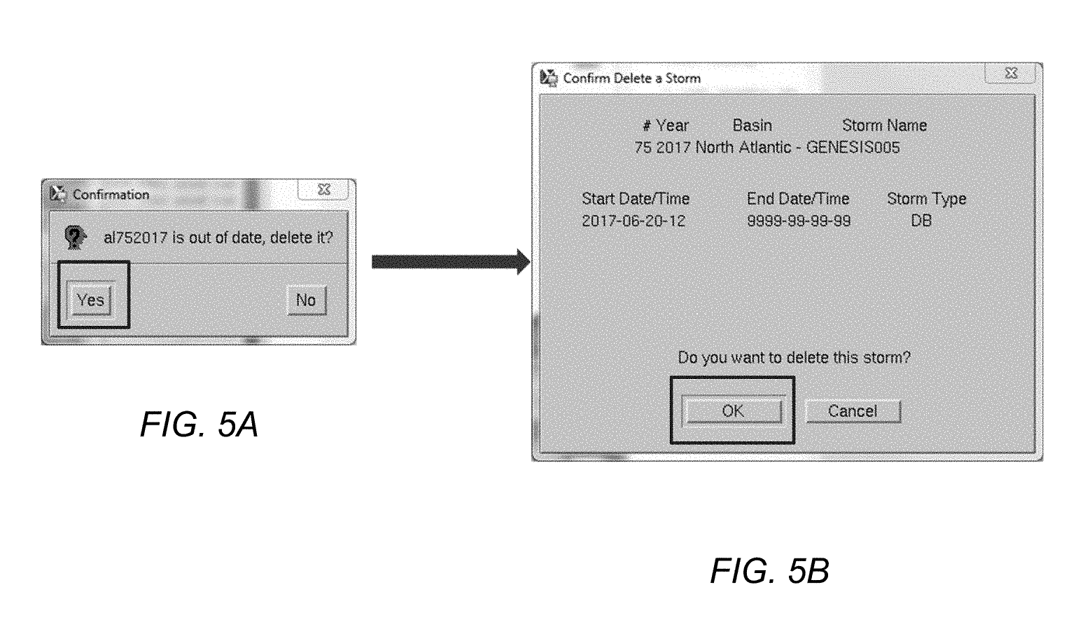

If the most recent genesis probability forecast for a particular genesis area is more than a week old, that probability forecast will not display in the dialog box, even though the genesis area will remain active until deleted by the user. If it has been more than 6 hours since a genesis forecast was updated, then records will be added (repeating the last position) to bring that genesis area up to date. However, if the forecast is 96 hours or more out of date, a new dialog box such as that illustrated in FIG. 5A will be generated asking the forecaster if he/she wants to delete the genesis area. If the forecaster selects “yes,” a “Delete a Storm” dialog box such as that shown in FIG. 5B will be generated, in which the forecaster can confirm that a specified genesis area should be deleted. For example, as shown in FIG. 5B, the dialog box asks whether genesis area GENESIS005 for the North Atlantic basin (which, as described above has also been assigned ATCF tracking number 75) should be deleted. If, on the other hand, the forecaster selects “no,” i.e., the forecaster does not want to delete the genesis area, the out-of-date genesis area will be retained but will not appear as one of the genesis areas for which a genesis probability can be assigned in the “IC Genesis Probability” dialog box. This genesis area is also tracked through the ATCF by means of its ATCF tracking number 75, and so whatever selection is made will be stored and tracked in the ATCF by updating the data file “$ATCFSTRMS/bal752017.dat” associated with that genesis area.

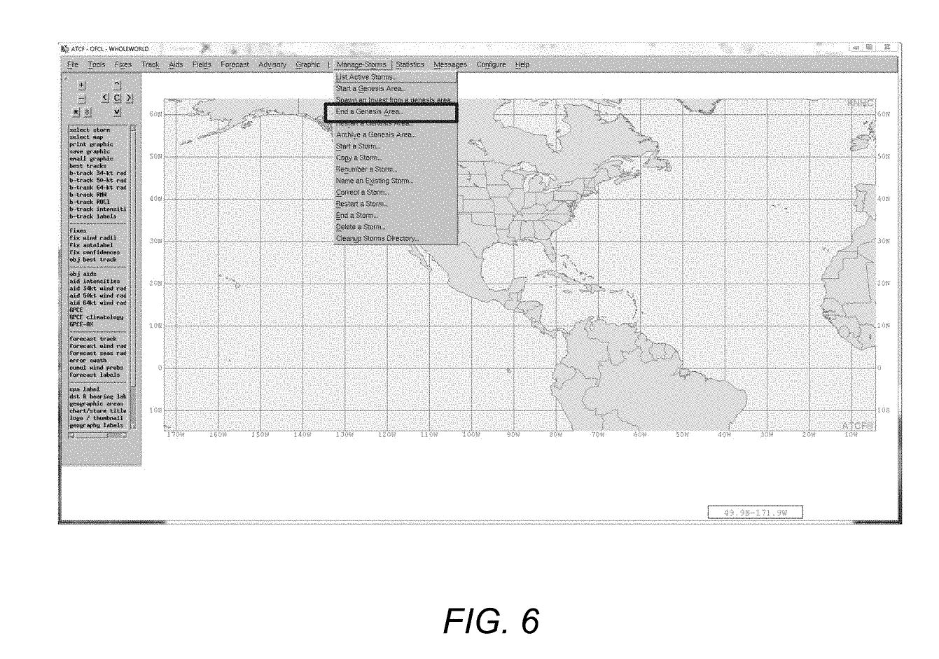

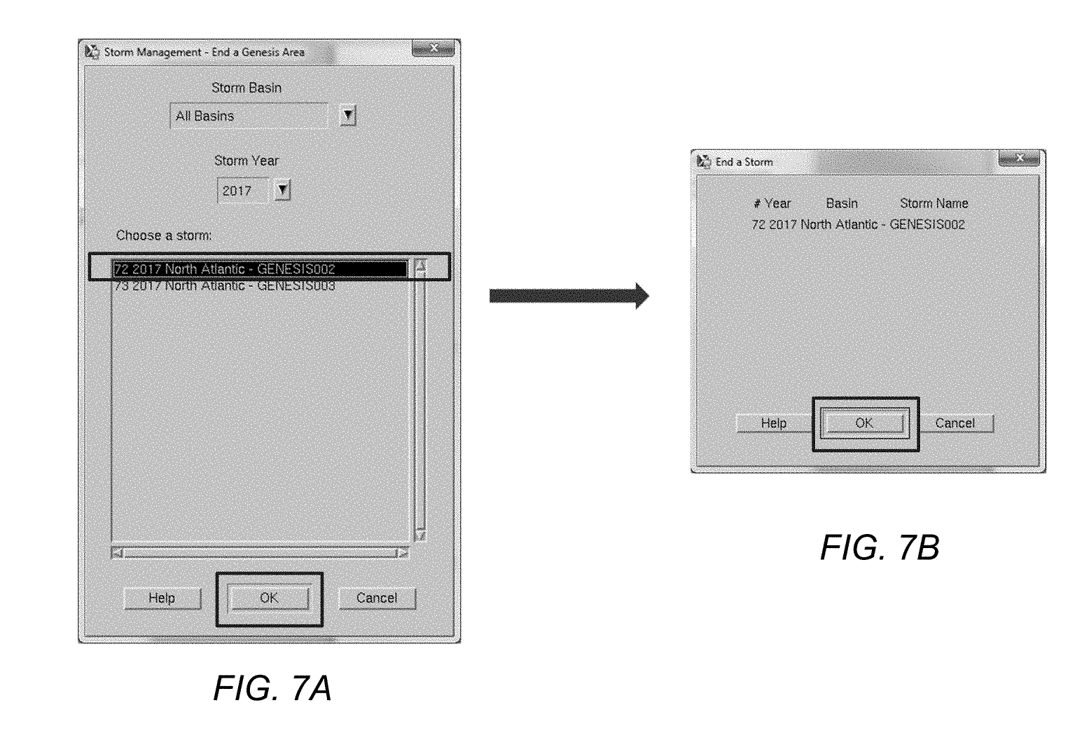

In many cases, a genesis area will not develop any further tropical storm characteristics, and in such cases, the forecaster can put the genesis area into an “inactive” status by selecting “Manage Storms/End a Genesis Area” in the user interface, as illustrated in FIG. 6. This selection opens a dialog box such as that shown in FIG. 7A, in which the forecaster can select a genesis area, e.g., “GENESIS002” in the North Atlantic Basin, to be ended, with the confirmation of the ending of that genesis area being made in a dialog box such as that shown in FIG. 7B. In addition, because the genesis area is tracked by its ATCF tracking number “72,” its status is updated in the ATCF data file “$ATCFSTRMS/ba1722017.dat” for that genesis area.

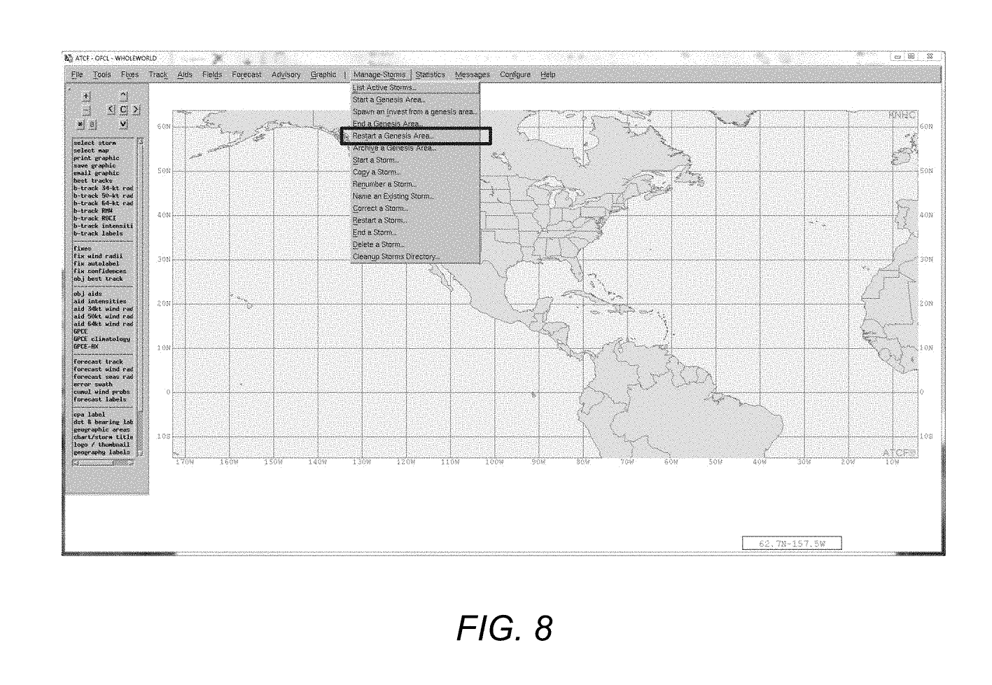

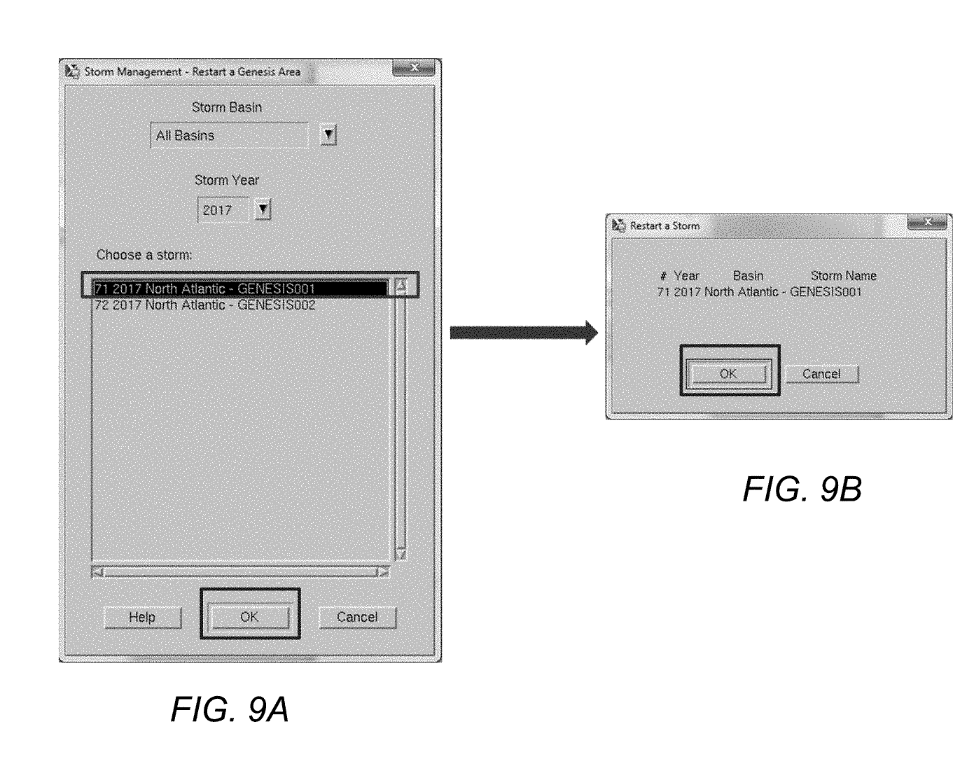

If the forecaster determines that such an inactive genesis area should be reactivated, e.g., because conditions for the development of a tropical storm reappear in the area), the forecaster can reactivate an inactive genesis area by clicking on “Manage Storms/Restart a Genesis Area” as shown in FIG. 8, which starts the dialog boxes shown in FIGS. 9A and 9B by which a forecaster can select a storm, e.g., GENESIS001 in the North Atlantic basin, to be restarted. Once restarted, the storm will be retain its original ATCF tracking number and its updated status will be reflected in the ATCF data file for that genesis area.

If the forecaster detects a disturbance inside the genesis area that appears to be the start of a tropical cyclone, an investigation area or “INVEST” is said to be “spawned” from that genesis area. More than one INVEST can be spawned in any given genesis area, and in accordance with the present invention, each of the spawned INVESTS can be traced back to the original genesis area.

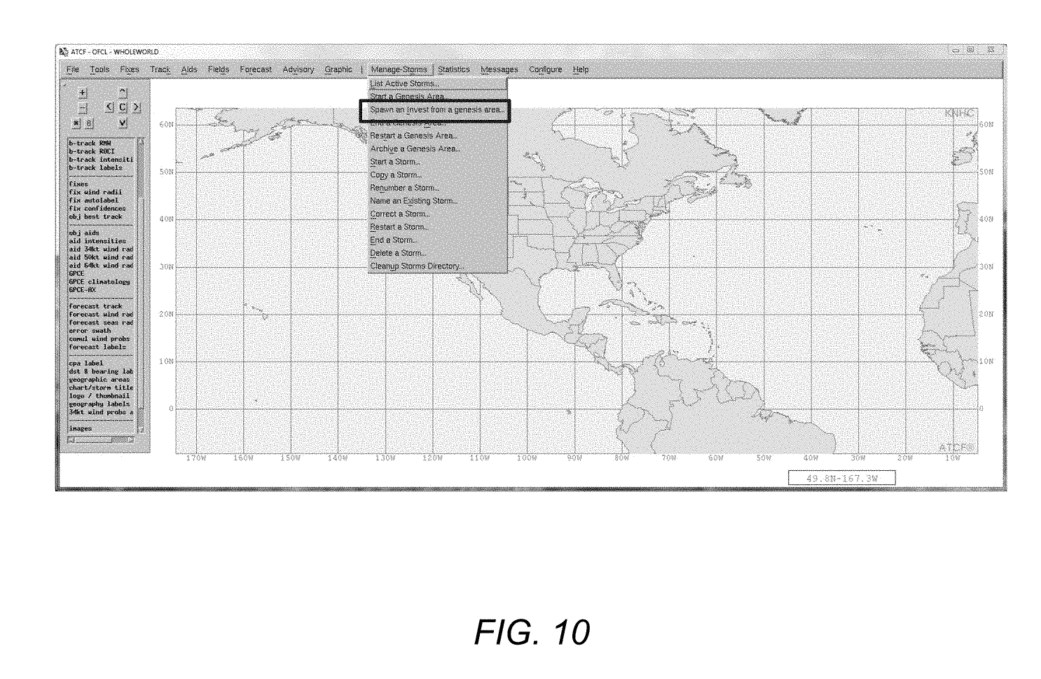

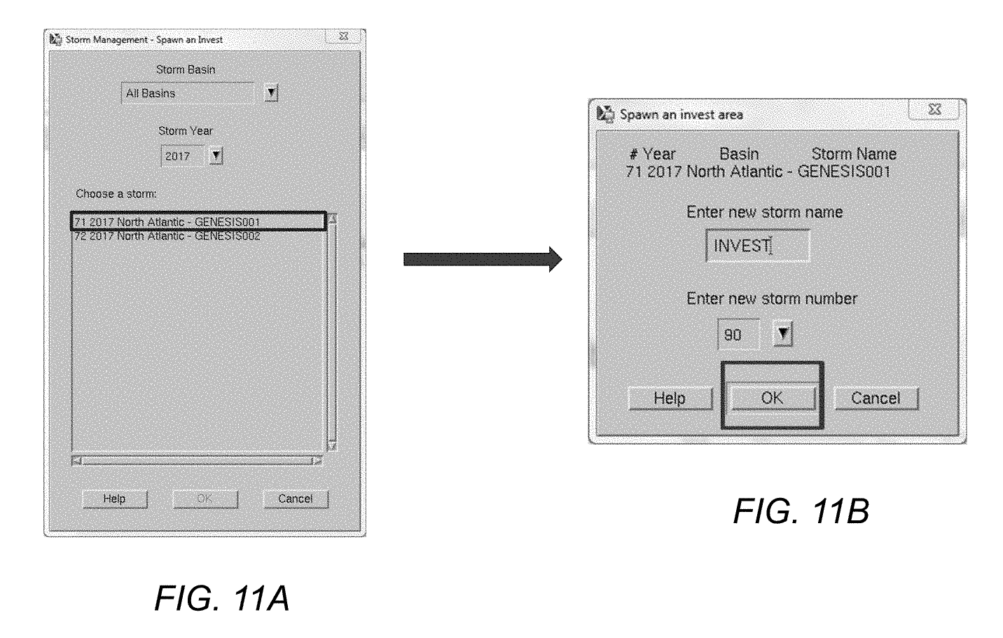

If it is determined that such an INVEST should be spawned, the forecaster can do so by clicking on “Manage Storms/Start an INVEST from a Genesis Area” as shown in FIG. 10. This selection opens a new set of dialog boxes such as those shown in FIGS. 11A and 11B in which the forecaster assigns an INVEST tracking number from 90 to 99 to an INVEST that has spawned from an existing storm. Thus, as shown in FIG. 11A, the forecaster can select the storm with which the INVEST is to be associated, e.g., the storm in the North Atlantic basin identified as “GENESIS001,” which has been given ATCF tracking number 71 by the ATCF genesis area definition and tracking system in accordance with the present invention. The INVEST is then given an INVEST storm name and is assigned an ATCF INVEST tracking number between 90 and 99 (often referred to as a “90's storm number”). For example, in the exemplary case illustrated in FIG. 11B, the storm in the North Atlantic basis identified as “GENESIS001” and by the ATCF tracking number 71 is given ATCF INVEST storm name/tracking number INVEST90. When the forecaster clicks “OK” to create this tracked invest, the storm files associated with the genesis area are updated to reflect the fact that the genesis has spawned an INVEST. Included in the updated files is all of the necessary information to map the data between the genesis and the INVEST.

If a tropical cyclone develops from any specific invest, that storm is assigned a number between 1 and 49 in accordance with the standard numbering system historically used by the National Hurricane Center and other forecasting agencies to refer to tropical cyclones in a given year. If the INVEST develops into an actual tropical cyclone, the data files related to that event will be updated to include all necessary information to map between the INVEST and the tropical cyclone.

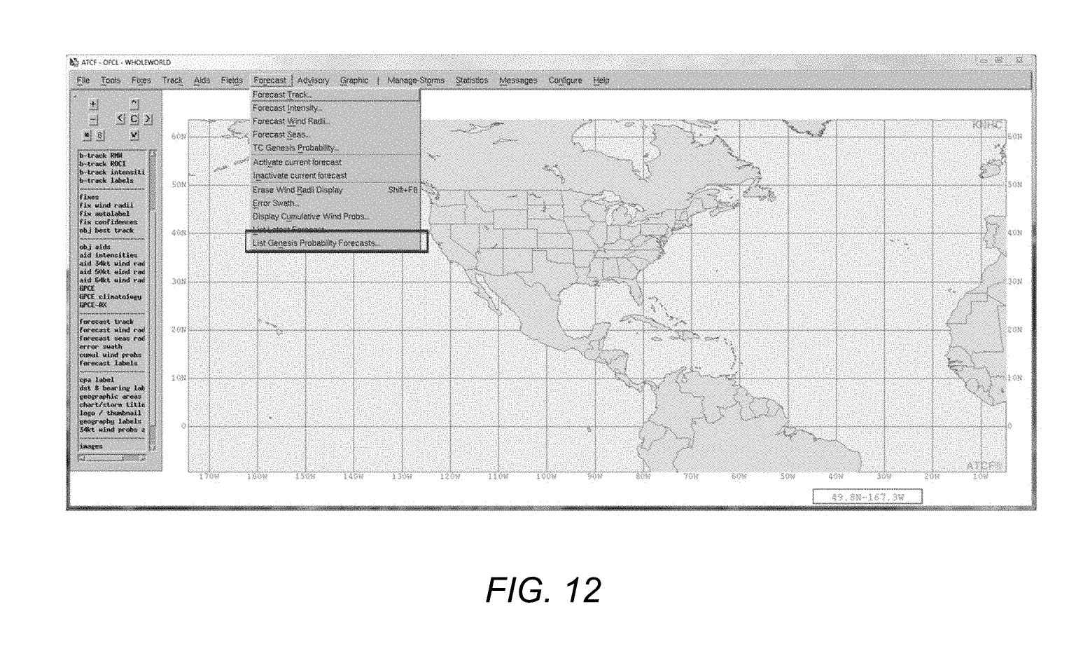

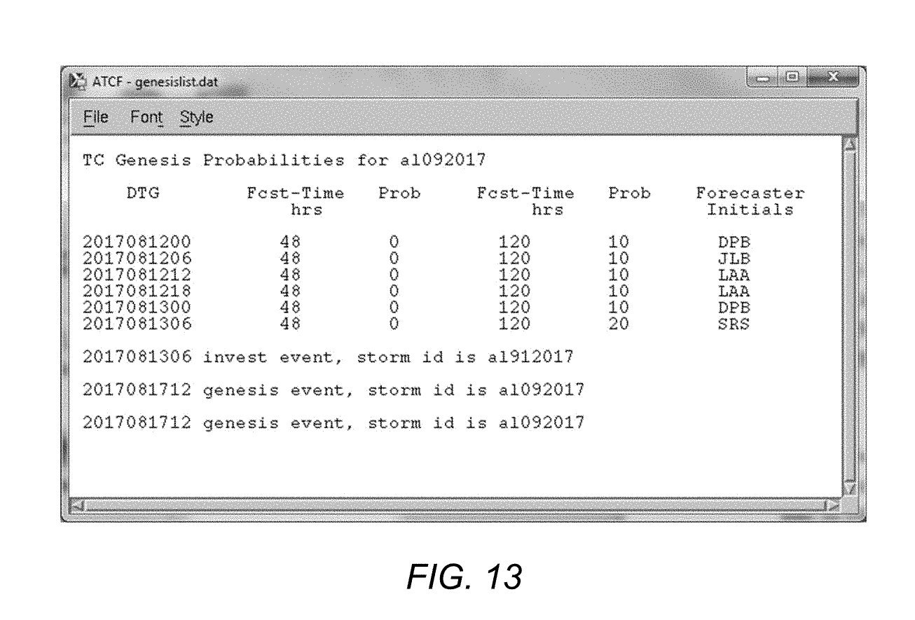

The ATCF genesis definition and tracking system in accordance with the present invention also enables a forecaster to quickly and easily access a listing of the current tropical cyclone genesis probability events for a given time period and/or a given storm basin. As shown in FIG. 12, such a listing of the current tropical cyclone genesis probability events for the current storm can be obtained by clicking on Forecast/“List Genesis Probability Forecasts,” which causes a listing of genesis events such as that illustrated in FIG. 13 to be displayed, where the listing also includes the genesis probability forecasts and also the invest, genesis, and dissipate events for the current storm.

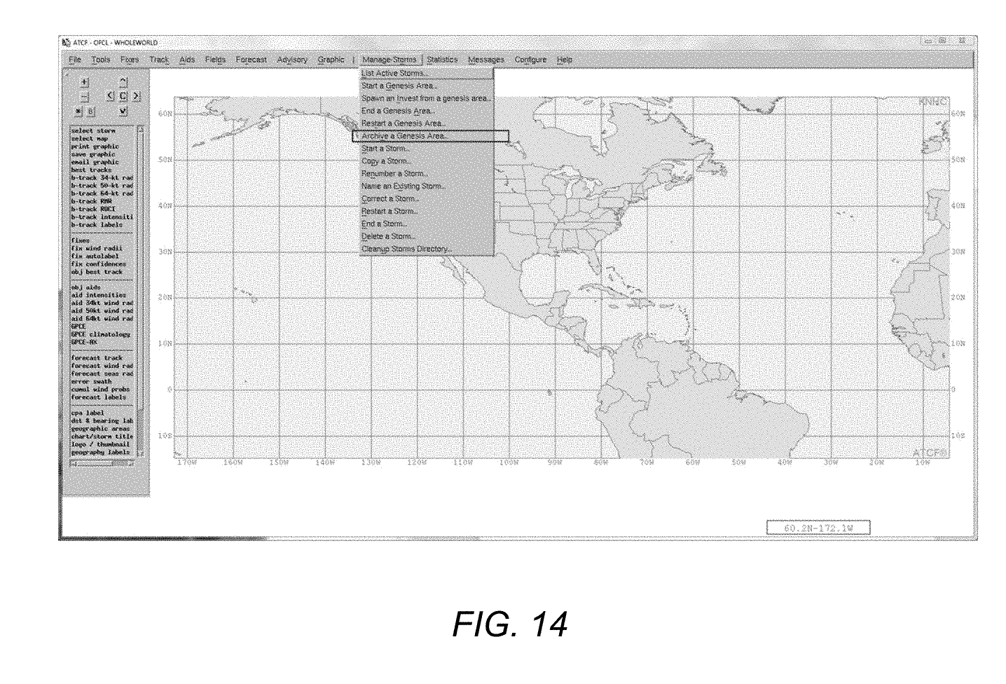

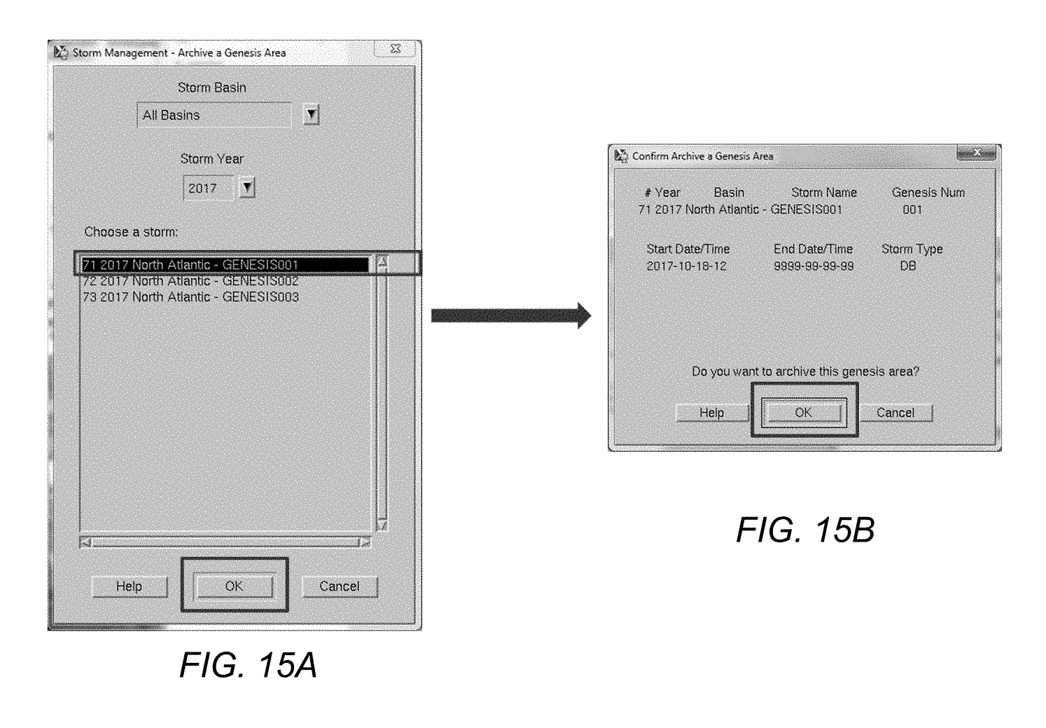

In addition to being defined, ended, and reactivated, the genesis areas can be archived through the user interface. Clicking on “Manage-storms/Archive a Genesis Area” as shown in FIG. 14 opens the dialog boxes shown in FIGS. 15A and 15B.

Thus, as shown in FIG. 15A, a genesis area can be archived by selecting the desired storm, e.g., “GENESIS001” in the North Atlantic basin (which, as described above is associated with ATCF tracking number 71 for the year 2017) and confirming that this storm should be archived by clicking on “OK” in the dialog box shown in FIG. 15B. Clicking “OK” saves the genesis area in the ATCF archives, deletes the area from the active storms list, and releases the ATCF tracking number (70-79) for use in tracking future genesis areas.

The genesis area files are archived using the filename format “<x><bb>_g<nnn><yyyy>.dat, e.g. bal_g0012017.dat,” where <x> is b, a, f, ore to denote forecast (“best-track”), aids, fixes, or probability data, respectively; <bb> denotes the basin where the genesis area is located, e.g., the Atlantic basin; <nnn> denotes the genesis area storm number for the year (001-999); and <yyyy> denotes the year.

In addition in accordance with the present invention, throughout the progress of a genesis area though the ATCF, tags are inserted into various ATCF files so that probabilities, INVESTS, TCs and other associated data can all be traced back to the genesis area.

For example, a tropical cyclone genesis event is saved to the probability database (also referred to in the system as the “e-deck”) when a warning or advisory is created (i.e. the storm state is changed from METWATCH or TCFA to WARNING) or when a storm is renumbered from a 90's ATCF INVEST tracking number to a numbered storm. Also at this time a “TRANSITIONED” user-defined tag is added to the forecast data.

If a storm is corrected and the storm state is downgraded from WARNING to either METWATCH or TCFA then a “dissipate” event is saved to the probability database (e-deck) and a DISSIPATED user-defined tag is added to the forecast data.

Advantages and New Features

A key innovation of our invention is the integration of the new TC genesis areas into the ATCF storm numbering and naming system. This innovation provides a significant improvement to TC tracking and analysis within the ATCF by allowing the new TC genesis area data, including data of the location, identity, and status of a TC genesis area, to be handled and stored in a manner that is compatible with the extensive and widely distributed existing ATCF storm database.

In accordance with the present invention, an active genesis area number will be unique for the selected basin and the year. Once a genesis area is archived, the tracking number that had been assigned to that genesis area is released for future use in active genesis tracking, reducing the number of tracking numbers needed.

Another innovation of the present invention is the tagging of all the events associated with the TC Genesis Areas in the ATCF database. The forecast and probabilities databases allow the forecaster actions on the TC genesis areas and associated spawned INVEST areas to be recorded in the ATCF database for use in real-time analysis of current storms as well as future review and analysis of past storms. An INVEST event is saved to the probability database when an INVEST area is spawned from a TC Genesis area. Also at this time a SPAWNINVEST tag is added to the forecast database. An actual genesis event (where the genesis area resulted in a TC) is saved to the probability database when an INVEST is renumbered to a numbered storm. Also at this time a “TRANSITIONED” tag is added to the forecast database. A “DISSIPATE” event is recorded in the ATCF probability data when a storm state is downgraded from “WARNING” status (i.e., when the TC dissipates to a point where the forecaster no longer forecasts it) or when a numbered storm is renumbered to an INVEST (this shouldn't happen, but ATCF needs to account for all sorts of events).

Alternatives

The only existing alternative to using the ATCF TC genesis tracking and analysis system and method of the present invention is to manually record each TC genesis area and associated event externally to the ATCF. Such a method is not automated and would be prone to human error and inefficiency. Such a method also would not allow the TC genesis area data to be integrated with the rest of the ATCF database nor would it allow for the tracking and analysis provided by the automated method of the present invention. Moreover, a manual method for identifying TC genesis areas over multiple years would be cumbersome as would studies involving multiple warning centers. Verifying INVESTS and genesis events at the end of the year would be difficult as the data required would not be convenient to retrieve from the disparate records. A manual system of tracking would probably not be standardized among forecasting centers. This would impair new research and development into automated aids and guidance for improved probabilistic forecasting of TC genesis events.

Thus the present invention provides a significant improvement over current methods for identifying, analyzing, and tracking tropical cyclone genesis areas and for managing data of such genesis areas. Although particular embodiments, aspects, and features of the present invention have been described and illustrated, one skilled in the art would readily appreciate that the invention described herein is not limited to only those embodiments, aspects, and features but also contemplates any and all modifications and alternative embodiments that are within the spirit and scope of the underlying invention described and claimed herein. The present application contemplates any and all modifications within the spirit and scope of the underlying invention described and claimed herein, and all such modifications and alternative embodiments are deemed to be within the scope and spirit of the present disclosure.

What is claimed is:

1. A computer-implemented method for defining and tracking a tropical cyclone (TC) genesis area in an automated tropical cyclone forecasting (ATCF) system, comprising:
receiving, at a computer programmed with appropriate software, TC genesis area initiation data indicative of an initiation of a TC genesis area, the TC genesis area comprising a user-specified geographical area in which climatological or environmental conditions are suitable for development of a tropical cyclone;
upon receipt of the TC genesis area initiation data, automatically assigning an ATCF tracking identifier to the TC genesis area to enable tracking of the TC genesis area, the tracking identifier having the form “<ATCF tracking number><year><basin><genesis_number>, where the ATCF tracking number is a two-digit number between 70 and 79, the year is the current year, the basin is a general geographical area known in the art where the TC genesis area is located, and genesis_number is in the form “GENESISXXX,” where “xxx” is a three-digit number between 001 and 999, and further upon receipt of the TC genesis initiation data, automatically generating, in the computer, a first TC genesis tracking file for storage of information regarding the TC genesis area;
receiving, at the computer, probability data indicative of an assignment of a probability that the TC genesis area will develop one or more tropical cyclones, and upon receipt of the probability data, saving the data of the probability assigned to a second TC genesis tracking file for storage of information regarding the TC genesis area;
receiving, at the computer, INVEST data indicating that the TC genesis area has spawned an INVEST, the INVEST comprising a geographical area within the TC genesis area which warrant further monitoring for possible development of a tropical cyclone;
upon receipt of the INVEST data, automatically assigning the INVEST within the TC genesis area an INVEST tracking number, where the INVEST tracking number is a two-digit number between 90 and 99, and further upon receipt of the INVEST data, updating the first and second TC genesis tracking files associated with the TC genesis area with the INVEST data and the INVEST tracking number for the INVEST; and
receiving, at the computer, tropical cyclone data indicative that the INVEST has developed into a tropical cyclone;
upon receipt of the tropical cyclone data, automatically assigning a storm number to the tropical cyclone, where the storm number is a two-digit number between 1 and 49, and further upon receipt of the tropical cyclone data, updating the first and second TC genesis tracking files with the tropical cyclone data; and
receiving, at the computer, archiving data indicative of an archiving of the TC genesis area; and upon receipt of the archiving data, making the ATCF tracking number and the INVEST number available for use to track future TC genesis areas.

2. A computer-implemented method for defining and tracking a tropical cyclone (TC) genesis area in an automated tropical cyclone forecasting (ATCF) system, comprising:
receiving, at a computer programmed with appropriate software, TC genesis area initiation data indicative of an initiation of a TC genesis area, the TC genesis area comprising a user-specified geographical area in which climatological or environmental conditions are suitable for development of a tropical cyclone;
upon receipt of the TC genesis area initiation data, automatically assigning an ATCF tracking identifier to the TC genesis area to enable tracking of the TC genesis area, the tracking identifier having the form “<ATCF tracking number><year><basin><genesis_number>, where the ATCF tracking number is a two-digit number between 70 and 79, the year is the current year, the basin is a general geographical area known in the art where the TC genesis area is located, and genesis_number is in the form “GENESISXXX,” where “xxx” is a three-digit number between 001 and 999, and further upon receipt of the TC genesis initiation data, automatically generating, in the computer, a first TC genesis tracking file for storage of information regarding the TC genesis area;
receiving, at the computer, probability data indicative of an assignment of a probability that the TC genesis area will develop one or more tropical cyclones, and upon receipt of the probability data, saving the data of the probability assigned to a second TC genesis tracking file for storage of information regarding the TC genesis area;
receiving, at the computer, delete storm data indicative of a deletion of the TC genesis area as an active genesis area; and
upon receipt of the delete storm data, automatically updating the first and second TC genesis files to reflect the deletion of the TC genesis area as an active genesis area and releasing the TC genesis area tracking number for use in connection with a future TC genesis area.

3. A computer-implemented method for defining and tracking a tropical cyclone (TC) genesis area in an automated tropical cyclone forecasting (ATCF) system, comprising:
receiving, at a computer programmed with appropriate software, TC genesis area initiation data indicative of an initiation of a TC genesis area, the TC genesis area comprising a user-specified geographical area in which climatological or environmental conditions are suitable for development of a tropical cyclone;
upon receipt of the TC genesis area initiation data, automatically assigning an ATCF tracking identifier to the TC genesis area to enable tracking of the TC genesis area, the tracking identifier having the form “<ATCF tracking number><year><basin><genesis_number>, where the ATCF tracking number is a two-digit number between 70 and 79, the year is the current year, the basin is a general geographical area known in the art where the TC genesis area is located, and genesis_number is in the form “GENESISXXX,” where “xxx” is a three-digit number between 001 and 999, and further upon receipt of the TC genesis initiation data, automatically generating, in the computer, a first TC genesis tracking file for storage of information regarding the TC genesis area;
receiving, at the computer, probability data indicative of an assignment of a probability that the TC genesis area will develop one or more tropical cyclones, and upon receipt of the probability data, saving the data of the probability assigned to a second TC genesis tracking file for storage of information regarding the TC genesis area;
receiving, at the computer, end TC genesis area data indicative of an ending of the TC genesis area as an active genesis area; and
upon receipt of the end TC genesis area data, automatically updating the first and second TC genesis files to reflect the ending of the TC genesis area as an active genesis area and releasing the TC genesis area tracking number for use in connection with a future TC genesis area.

4. The computer-implemented method for defining and tracking a tropical cyclone (TC) genesis area according to claim 3, further comprising receiving, at the computer, TC genesis area reactivation data indicative of a reactivation of an ended TC genesis area, the reactivated TC genesis area being reassigned its original ATCF tracking number upon reactivation.
